(19) United States
(12) Patent Application Publication
(10) Pub. No.: US 2010/0073275 A1
(43) Pub. Date: Mar. 25, 2010

(54) BACKLIGHT DEVICE AND METHOD OF DRIVING SAME

(76) Inventor: Jong-Tae KIM, Asan-si (KR)

Correspondence Address: Haynes and Boone, LLP;IP Section, 2323 Victory Avenue, SUITE 700, Dallas, TX, 75219, US

(21) Appl. No.: 12/398,988

(22) Filed: Mar. 5, 2009

(30) Foreign Application Priority Data
Sep. 25, 2008 (KR) 2008-0094085

(51) Int. Cl. G09G 3/36

(52) U.S. Cl. 345/102

(57) ABSTRACT

A backlight device includes a backlight array that provides light to a display panel such that the display panel displays an image in accordance with one or more embodiments. The backlight device may include a plurality of backlight drivers that drive the backlight array and a controller that selects one of the backlight drivers in response to backlight driving information supplied from an external device and transmits the backlight driving information to the selected backlight driver.

### CROSS-REFERENCE TO RELATED APPLICATIONS

This application claims priority to and the benefit of Korean Patent Application No. 2008-0094085, filed on Sep. 25, 2008, the contents of which are herein incorporated by reference in their entirety.

### BACKGROUND

1. Technical Field

The present invention generally relates to a display apparatus and, more particularly, to a backlight device for a display apparatus and a method for driving the backlight device.

2. Related Art

Display devices have recently been required to be thinner and more lightweight as electronic appliances, such as personal computers and televisions, have tended to be thinner and lightweight. Thus, a flat panel type display such as a liquid crystal display (LCD) has been researched and developed instead of a cathode ray tube (CRT).

An LCD includes a liquid crystal material that is injected between two substrates and has an anisotropic dielectric constant. When applying an electric field to the liquid crystal material and adjusting intensity of the electric field, the amount of transmission light passing through the substrate is adjusted. As a result, the LCD displays desired images on its screen.

Since the LCD is not a self-emissive flat panel display device, the LCD essentially requires light from an exterior source to display the images. In order to supply the light to the LCD, the LCD includes a backlight unit disposed at a rear surface of the LCD.

For the backlight unit, cold cathode fluorescent lamps have mainly been used, but in recent years light emitting diodes have been the subject of steadily increasing attention as an advanced light source for the backlight unit because light emitting diodes reduce power consumption and improve color reproducibility.

### BRIEF SUMMARY

An embodiment of the present invention provides a backlight device that realizes high brightness using light emitting diodes.

Another embodiment of the present invention provides a method of driving the backlight device.

In an embodiment of the present invention, a backlight device includes a backlight array that provides light to a display panel so that the display panel displays an image, a plurality of backlight drivers that drives the backlight array, and a controller that selects one of the backlight drivers in response to backlight driving information supplied from an external device and transmits the backlight driving information to the selected backlight driver.

The controller includes a plurality of channels connected to the backlight drivers, respectively, and a multiplexer that enables one of the channels in response to the backlight driving information. The backlight driving information includes channel selection information to select one of the channels. The channel selection information includes a combination of a prescribed number of bits. The backlight driving information is transmitted through a system management bus scheme.

In another embodiment of the present invention, a method of driving a backlight device includes selecting one of a plurality of backlight drivers to drive a backlight array in response to backlight driving information supplied from an external device; transmitting the backlight driving information to the selected backlight driver; generating a driving signal based on the backlight driving information; and generating light in response to the driving signal.

In another embodiment of the present invention, a display apparatus includes a display panel displaying an image, and a backlight unit providing the display panel with a light in response to backlight driving information supplied from an external device. The backlight unit includes a backlight array providing the display panel with the light, a plurality of backlight drivers driving the backlight array, and a controller that selects one backlight driver of the backlight drivers in response to backlight driving information and transmits the backlight driving information to the selected backlight driver.

According to the above, the backlight device may realize high brightness by employing the emitting diodes.

### BRIEF DESCRIPTION OF THE DRAWINGS

The above and other aspects, advantages and features of embodiments of the present invention will become readily apparent by reference to the following detailed description when considered in conjunction with the accompanying drawings wherein:

FIG. 1 is a block diagram showing an LCD according to an embodiment of the present invention;

FIG. 2 is a block diagram of a backlight unit shown in FIG. 1 according to an embodiment of the present invention;

FIG. 3 is a block diagram of a first LED group shown in FIG. 2 according to an embodiment of the present invention;

FIG. 4 is a circuit diagram of a multiplexer IC (integrated circuit) shown in FIG. 2 according to an embodiment of the present invention;

FIG. 5 is a diagram showing an example of a data format according to a SMBUS scheme in accordance with an embodiment of the present invention;

FIG. 6 is a diagram showing a structure of a data byte shown in FIG. 5 in accordance with an embodiment of the present invention;

FIG. 7 is a plan view showing a backlight array according to an embodiment of the present invention;

FIG. 8 is a plan view showing another example of a backlight array according to an embodiment of the present invention;

FIG. 9 is a plan view showing another example of a backlight unit according to an embodiment of the present invention;

FIG. 10 is a plan view showing another example of a backlight unit according to an embodiment of the present invention; and

FIG. 11 is a flowchart illustrating a method of driving a backlight unit according to an embodiment of the present invention.

### DETAILED DESCRIPTION

Hereinafter, embodiments of the present invention will be explained in further detail with reference to the accompanying drawings.

In the description, a liquid crystal display (LCD) will be explained as an example of a display apparatus according to an embodiment of the present invention. Embodiments of the present invention, however, may be employed in other light-receiving type display apparatuses, for example, an Electro Chemical Display (ECD), an Electro Phonetic Image Display (EPID), a Twisting Ball Display (TBD), or a Suspended Particle Display (SPD), as will be obvious to those having ordinary skill in the art.

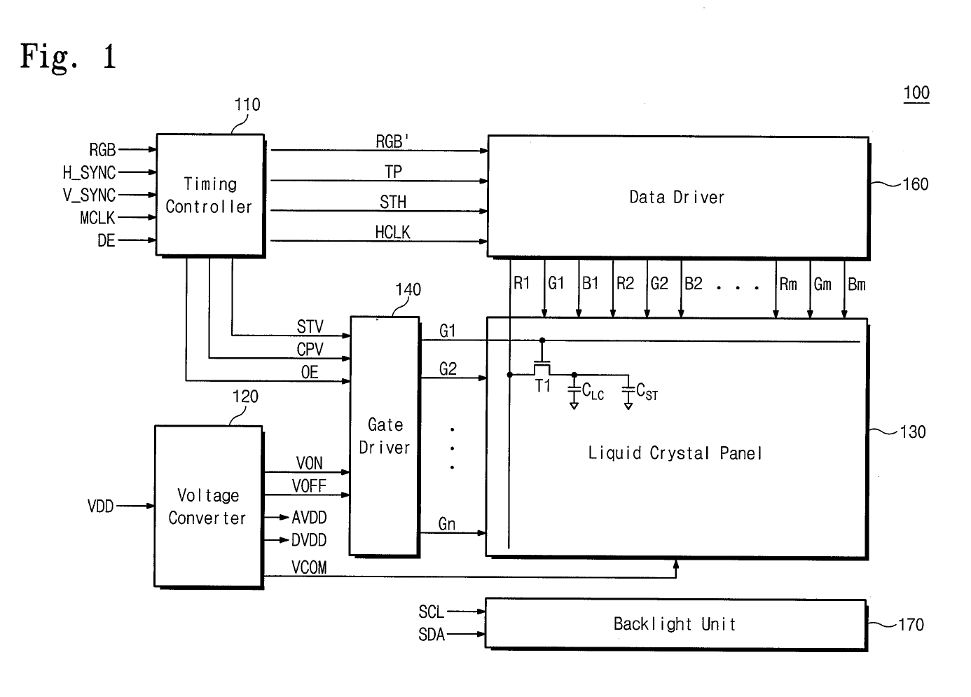

FIG. 1 is a block diagram of an LCD according to an embodiment of the present invention.

Referring to FIG. 1, an LCD 100 includes a timing controller 110, a voltage converter 120, a liquid crystal panel 130, a gate driver 140, a data driver 160, and a backlight unit 170.

The timing controller 110 receives a pixel data signal RGB, a horizontal synchronization signal H_SYNC, a vertical synchronization signal V_SYNC, a clock signal MCLK, and a data enable signal DE. The timing controller 110 converts a data format of the pixel data signal RGB into a data format appropriate for an interface between the data driver 160 and the timing controller 110, and outputs a pixel data signal RGB′ having the converted data format and control signals to the data driver 160. The control signals applied to the data driver 160 from the timing controller 110 include an output starting signal TP, a horizontal synchronization starting signal STH, and a clock signal HCLK. The timing controller 110 also outputs a vertical synchronization starting signal STV, a gate clock signal CPV, and an output enable signal OE to the gate driver 140.

The voltage converter 120 receives a direct current power source voltage VDD from an exterior power source and generates a plurality of voltages required to drive the LCD 100. The voltages to drive the LCD 100 include, for example, an analog power voltage AVDD, a digital power voltage DVDD, a gate on voltage VON, a gate off voltage VOFF, and a common voltage VCOM. The gate on voltage VON and the gate off voltage VOFF are applied to the gate driver 140, and the analog power voltage AVDD and the digital power voltage DVDD are used as operating voltages of the LCD. The common voltage VCOM is applied to a common electrode of the liquid crystal panel 130. The voltage converter 120 may be configured to have a direct current to direct current converter (DC/DC converter).

The liquid crystal panel 130 includes a plurality of gate lines G1-Gn, a plurality of data lines R1-Rm, G1-Gm, and B1-Bm crossing the gate lines G1-Gn, and a plurality of pixels that are arranged in pixel areas defined by the gate lines G1-Gn and the data lines R1-Rm, G1-Gm, and B1-Bm. Each pixel has a thin film transistor T1, a liquid crystal capacitor C_{LC}, and a storage capacitor C_{ST}. The thin film transistor T1 includes a gate electrode connected to a corresponding gate line of the gate lines G1-Gn, a source electrode connected to a corresponding data line of the data lines R1-Rm, G1-Gm, and B1-Bm, and a drain electrode connected to the liquid crystal capacitor C_{LC} and the storage capacitor C_{ST}.

In the above pixel structure, the gate lines G1-Gn are sequentially selected by the gate driver 140, and the gate on voltage VON is applied to the selected gate line in a pulse form. Accordingly, the thin film transistor T1 connected to the selected gate line is turned on, and then a voltage (hereinafter, referred to as a data voltage) including pixel information may be applied to the data lines R1-Rm, G1-Gm, and B1-Bm by the data driver 160. The data voltage is applied to the liquid crystal capacitor C_{LC} and the storage capacitor C_{ST} through the thin film transistor T1 of a corresponding pixel.

The liquid crystal capacitor C_{LC} transmits light in accordance with the data voltage provided through the turned-on thin film transistor T1, and the storage capacitor C_{ST} stores the data voltage supplied through the turned-on thin film transistor T1. When the thin film transistor T1 is turned off, the storage capacitor C_{ST} supplies the stored data voltage to the liquid crystal capacitor C_{LC}. Thus, the liquid crystal panel 130 may display an image.

Each pixel arranged in the liquid crystal panel 130 includes three sub-pixels that correspond, respectively, to a red color, a green color, and a blue color. The sub-pixels are sequentially arranged in a length direction of the gate lines G1-Gn. Also, the liquid crystal panel 130 includes a common electrode (not shown) that is arranged above the sub-pixels and receives the common voltage VCOM.

The gate driver 140 sequentially scans the gate lines G1-Gn of the liquid crystal panel 130 in response to the control signals from the timing controller 110. In the present example, the scanning is defined as sequentially supplying the gate on voltage VON to the gate lines G1-Gn so as to enable writing the data into the pixels connected to a gate line to which the gate on voltage VON is applied.

The data driver 160 generates a plurality of gray scale voltages using a plurality of gamma voltages supplied from a gamma voltage generator (not shown). The data driver 160 selects gray scale voltages corresponding to the pixel data signal RGB′ in response to the control signals from the timing controller 110, and outputs the selected gray scale voltages to the data lines R1˜Rm, G1-Gm, and B1-Bm of the liquid crystal panel 130.

To drive the LCD 100, when the gate on voltage VON is applied to the gate electrode of the thin film transistor T1 connected to the selected gate line, the thin film transistor T1 is turned on. Then, when the data voltage corresponding to the pixel data signal is applied to the source electrode of the thin film transistor T1, the data voltage may be applied to the drain electrode through the turned-on thin film transistor T1. Also, when the common voltage VCOM is applied to the common electrode of the liquid crystal panel 130, the liquid crystal is driven by a voltage difference between the common voltage VCOM and the data voltage. Thus, the LCD 100 may display an image.

The backlight unit 170 provides the liquid crystal panel 130 with light in response to a data signal SDA and a clock signal SCL supplied from an external device (not shown) through a system management bus (SMBUS) scheme. The data signal SDA may include brightness control information, feedback information between the backlight unit 170 and the external device, error sensing information, and dimming control information, for example, but the present invention is not limited thereto.

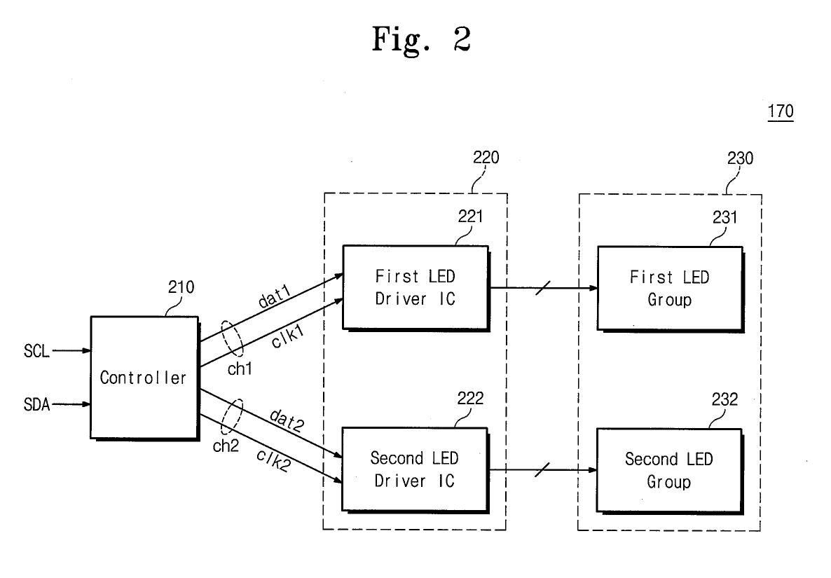

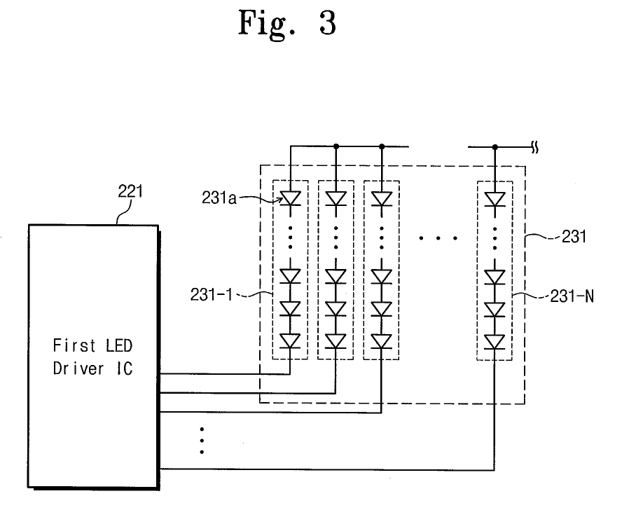

FIG. 2 is a block diagram of the backlight unit shown in FIG. 1, and FIG. 3 is a block diagram of a first LED group shown in FIG. 2 in accordance with one or more embodiments.

Referring to FIG. 2, the backlight unit 170 includes a controller 210 (also referred to as “multiplexer IC”), a backlight driver 220, and a backlight array 230.

The controller 210 includes a multiplexer integrated circuit (IC) having a multiplexer and receives the data signal SDA and the clock signal SCL from the external device using the SMBUS scheme. The multiplexer IC 210 is connected to the backlight driver 220 through two channels (ch1 and ch2). In the present example, the data signal SDA and the clock signal SCL may include channel selection information to select one channel of the two channels. Thus, the multiplexer IC 210 outputs a signal to the channel selected by the channel selection information.

The backlight driver 220 includes a first light emitting diode (LED) driver IC 221 and a second LED driver IC 222. The first LED driver IC 221 and the second LED driver IC 222 are connected to the multiplexer IC 210 through separate channels. In particular, the first LED driver IC 221 receives a first data signal dat1 and a first clock signal clk1 from the multiplexer IC 210 through the first channel ch1, and the second LED driver IC 222 receives a second data signal dat2 and a second clock signal clk2 from the multiplexer IC 210 through the second channel ch2.

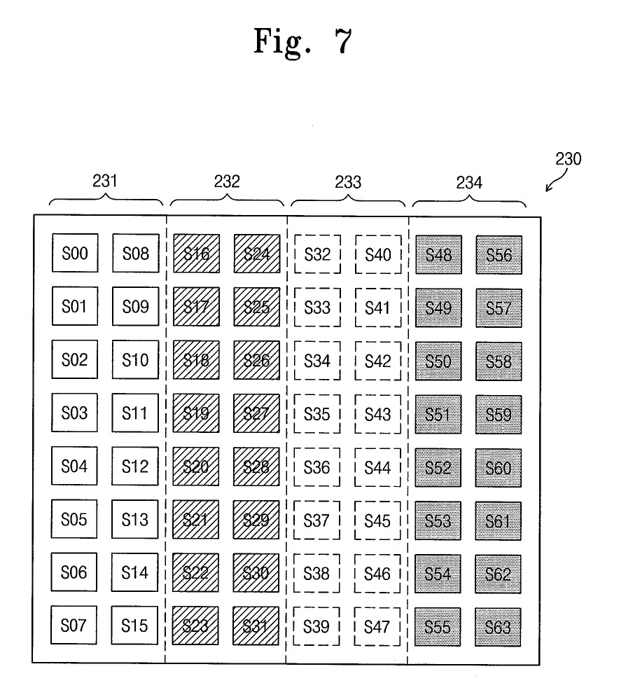

The backlight array 230 is disposed at a rear face of the liquid crystal panel 130 shown in FIG. 1, and provides the liquid crystal panel 130 with light. In the present example, the backlight array 230 includes a first LED group 231 and a second LED group 232. Each of the first and second LED groups 231 and 232 includes a plurality of LEDs (not shown). As shown in FIG. 3, the first LED group 231 may include one or more sub-LED groups 231-1˜231-N, each of which includes a plurality of LEDs 231a connected to each other in series. Details of a structure of the backlight unit 170 will be described later with reference to FIGS. 7 to 9.

In FIG. 2, the backlight array 230 including two LED groups 231 and 232 have been shown, but the number of the LED groups included in the backlight array 230 is not limited by the example, and may be either less than or more than two.

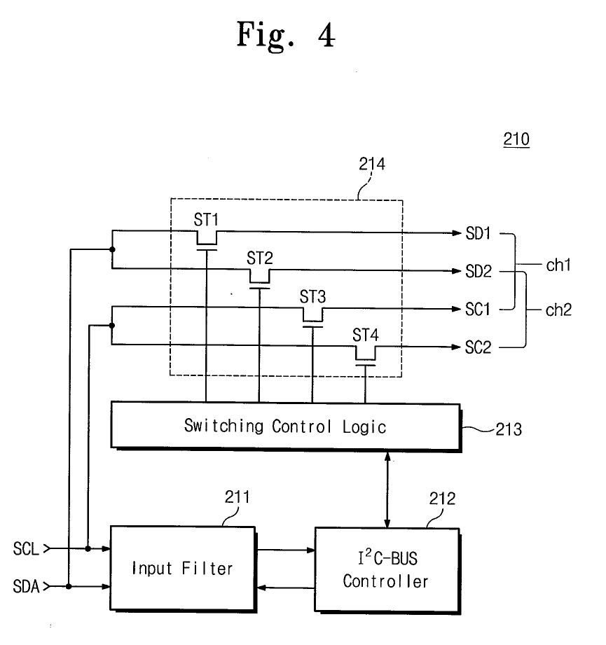

For example, in case that the number of the LEDs capable of being driven by one LED driver IC is limited to 60, if the number of the LEDs included in the backlight array 230 is increased to 84, the 84 LEDs may be divided into two LED groups, and the backlight driver 220 may include two LED driver ICs to drive the two LED groups. That is, since the driving ability of each LED driver IC is limited, if the number of the LEDs included in the backlight array 230 is increased, the number of the LED driver ICs may correspondingly be increased. For the example of driving each LED driver IC using the SMBUS scheme, the number of the channels connecting the LED driver ICs to the multiplexer IC 210 may be increased, and yet a signal may be output only through the selected channel, thereby preventing addresses from colliding. To this end, the multiplexer IC 210 may have the structure as shown in FIG. 4.

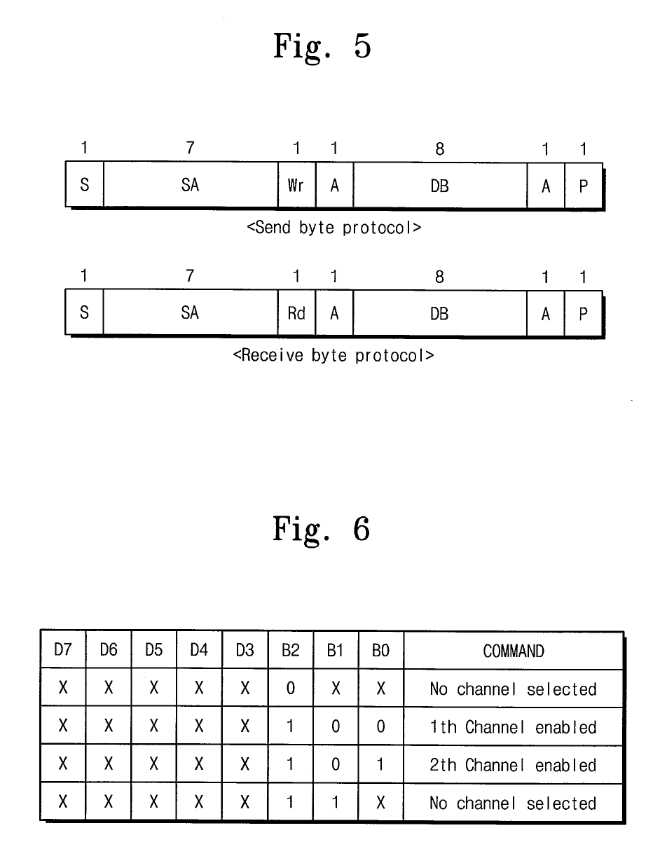

FIG. 4 is a circuit diagram of the multiplexer IC shown in FIG. 2, FIG. 5 is a diagram showing an example of a data format according to an SMBUS scheme, and FIG. 6 is a diagram showing a structure of a data byte shown in FIG. 5 in accordance with one or more embodiments.

Referring to FIG. 4, the multiplexer IC 210 includes an input filter 211, an I²C (Inter-Integrated Circuit) bus controller 212, a switching control logic 213, and a switching circuit 214.

The input filter 211 filters the data signal SDA and the clock signal SCL that are input through the SMBUS scheme and extracts channel selection information from the data signal SDA and the clock signal SCL. The extracted channel selection information is transmitted to the I²C bus controller 212, and the I²C bus controller 212 processes the channel selection information and transmits the processed channel selection information to the switching control logic 213 using the I²C bus interfacing method.

As shown in FIG. 5, the data signal SDA in the SMBUS scheme includes a start bit S to indicate the start of the data communication, a slave address SA including information for a communication target device of a plurality of devices that are connected to each other through the SMBUS, a bit Wr or Rd to indicate, respectively, writing of the data or reading of the data, a data byte DB to indicate a communication target data, and a stop bit P to indicate the end (or stopping) of the data communication. In addition, the data signal SDA further includes an acknowledgment signal A to check successful receiving of the transmitted data.

In the present example, the data byte DB includes the channel selection information required to select the channel in the multiplexer IC 210. Accordingly, the multiplexer IC 210 enables a corresponding channel based on the channel selection information included in the data byte DB from the external device using the SMBUS scheme.

Referring to FIG. 6, lower-order three bits B2, B1, B0 of the data byte DB are used to select the channel in the multiplexer IC 210. For the present example, when the lower-order three bits B2, B1, B0 are 0XX or 11X, the multiplexer IC 210 does not select a channel. Also, when the lower-order three bits B2, B1, B0 of the data byte DB are 100, the multiplexer IC 210 selects the first channel ch1, and when the lower-order three bits B2, B1, B0 of the data byte DB are 101, the multiplexer IC 210 selects the second channel ch2.

Referring again to FIG. 4, the switching control logic 213 generates a switching signal based on the channel selection information and supplies the switching signal to the switching circuit 214. The switching circuit 214 includes a first switching device ST1, a second switching device ST2, a third switching device ST3 and a fourth switching device ST4. The first channel ch1 includes a first data bus SD1 and a first clock bus SC1. The second channel ch2 includes a second data bus SD2 and a second clock bus SC2.

The first and second switching devices ST1 and ST2 select one of the first and second data buses SD1 and SD2 in response to the switching signal and supply the data SDA provided from the external device using the SMBUS scheme to the selected data bus SD1 or SD2. Also, the third and fourth switching devices ST3 and ST4 select one of the first and second clock buses SC1 and SC2 and supply the clock SCL provided from the external device using the SMBUS scheme to the selected clock bus SC1 or SC2.

Thus, although the number of the LED driver ICs may be increased, the multiplexer IC 210 assigns a separate channel to each of the LED driver ICs and selects a corresponding channel, thereby normally controlling an operation of all the LED driver ICs included in the backlight driver 220.

FIG. 7 is a plan view showing an example of a backlight array according to an embodiment of the present invention. In FIG. 7, a direct-illumination type backlight unit is shown, in which the backlight array is arranged directly under the liquid crystal panel.

Referring to FIG. 7, a backlight array 230 includes a first LED group 231, a second LED group 232, a third LED group 233, and a fourth LED group 234. In the present example, each LED group has sixteen sub-LED groups. Therefore, the backlight array 230 includes sixty four sub-LED groups S00˜S63 in total. Although not shown in FIG. 7, each of the sub-LED groups S00˜S63 may include a plurality of light emitting diodes.

Although not shown in the figures, the first to fourth LED groups 231˜234 are connected to the first to fourth LED driver ICs, respectively, and receive a driving signal from the first to fourth LED driver ICs, respectively. In this case, each LED group may be defined as a set of the sub-LED groups that are connected to same driver IC.

As shown in FIG. 7, the sub-LED groups included in the same LED group may be arranged adjacent to each other.

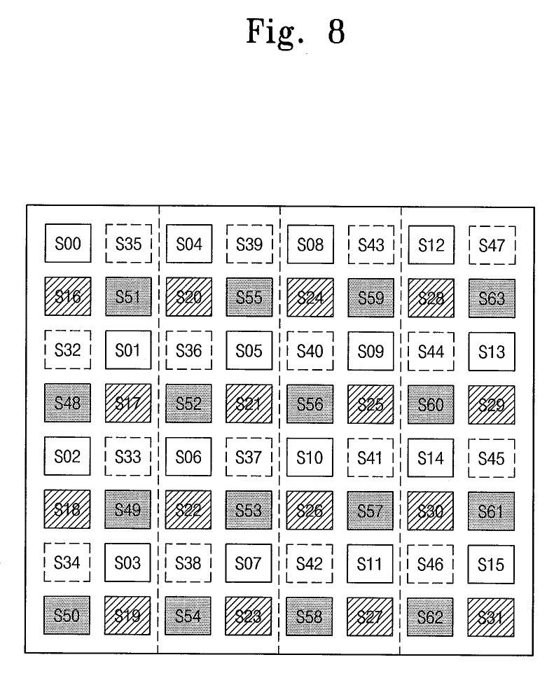

FIG. 8 is a plan view showing another example of a backlight array according to an embodiment of the present invention.

Referring to FIG. 8, in case that each LED group is defined as a set of sub-LED groups that are connected to same driver IC, the sub-LED groups included in the same LED group may be alternately arranged with respect to each other. For example, at least one sub-LED group included in a different (e.g., second) LED group may be arranged between sub-LED groups included in the same (e.g., first) LED group.

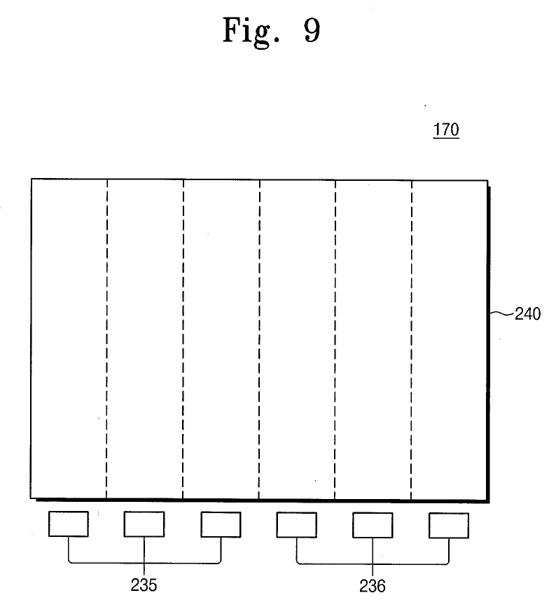

FIG. 9 is a plan view showing another example of a backlight unit according to an embodiment of the present invention.

Referring to FIG. 9, a backlight unit 170 includes a light guide plate 240, a first LED group 235, and a second LED group 236, which are arranged adjacent to a side surface of the light guide plate 240. In this example, each LED group is defined as a set of the sub-LED groups that are connected to the same driver IC, each LED group includes three sub-LED groups, and the sub-LED groups included in the same LED group may be arranged adjacent to each other, as shown.

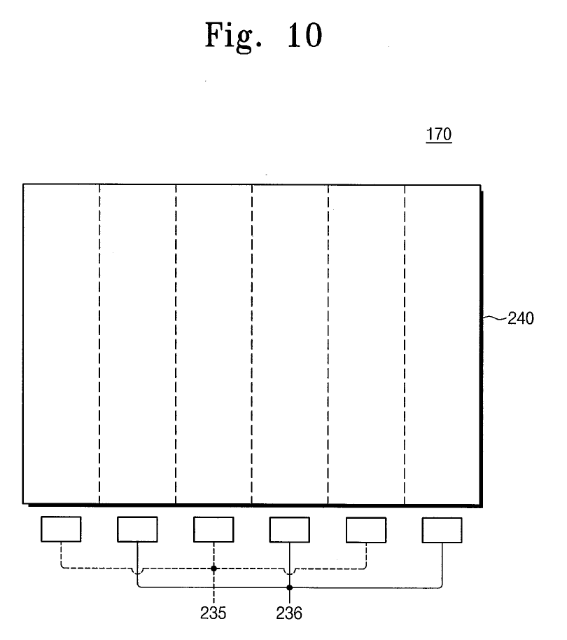

FIG. 10 is a plan view showing another example of a backlight unit according to an embodiment of the present invention.

Referring to FIG. 10, a backlight unit 170 includes a light guide plate 240, a first LED group 235, and a second LED group 236, which are arranged adjacent to a side surface of the light guide plate 240. In this example, each LED group is defined as a set of the sub-LED groups that are connected to the same driver IC, each LED group includes three sub-LED groups, and the sub-LED groups included in the same LED group may be alternately arranged with respect to each other, as shown.

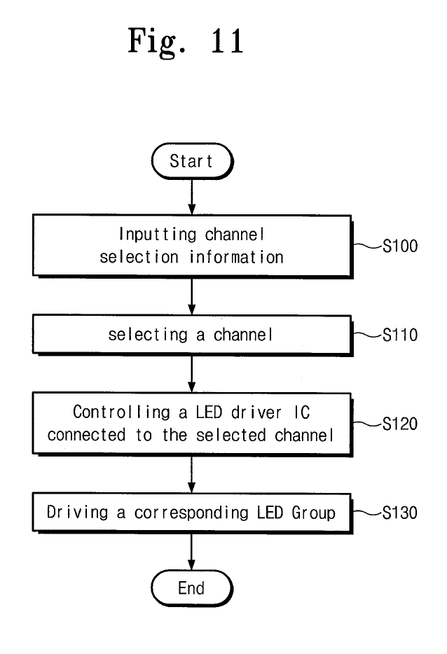

FIG. 11 is a flowchart illustrating a method of driving the backlight unit 170 according to an embodiment of the present invention

Referring to FIG. 11, backlight driving information supplied to a backlight unit 170 from the external device (e.g., using the SMBUS scheme) includes channel selection information (S100). A multiplexer IC 210 selects a corresponding channel according to the channel selection information (S110). Then, a communication between the external device and LED driver ICs 221 and 222 connected to the selected channel may be performed. The external device may, e.g., via controller 210, control the LED driver ICs 221 and 222 connected to the selected channel (S120) to drive corresponding LED groups 231 and 232 (S130).

Hereinafter, the method of driving the backlight unit 170 will be described under the assumption that the first LED driver IC 221 of the LED driver ICs 221 and 222 is connected to a first channel ch1 of the multiplexer IC 210, and the second LED driver IC 222 of the LED driver ICs 221 and 222 is connected to a second channel ch2 of the multiplexer IC 210.

The external device transmits a slave address to the backlight unit 170 using the SMBUS scheme. The slave address is an address for the multiplexer IC 210. For example, when the address of the multiplexer IC 210 is 0X70, the address of 0X70 may serve as the slave address. Then, the multiplexer IC 210 may output the acknowledgment signal A. After that, the data byte may be input to the backlight unit 170 from the external device. The data byte may include bits to select the channels.

As shown in FIG. 6, in the present example, the bits used to select the XXXXX100, the first channel ch1 of the multiplexer IC 210 is selected. If the first channel ch1 is selected, the communication may be performed between the external device and the first LED driver IC 221 connected to the first channel ch1. Thus, the external device controls the first LED driver IC 221, so that the first LED group 231 connected to the first LED driver IC 221 may be driven.

Similarly, when, for example, the data byte is XXXXX101, the second channel ch2 of the multiplexer IC 210 is selected. If the second channel ch2 is selected, the communication may be performed between the external device and the second LED driver IC 222 connected to the second channel ch2. Therefore, the external device controls the second driver IC 222 to drive the second LED group 232 connected to the second LED driver IC 222.

According to the present example, the communication between the external device and the first and second LED drivers 221 and 222 is performed after selecting either the first LED driver IC 221 or the second LED driver IC 222 so that collision of addresses may be prevented.

Although exemplary embodiments of the present invention have been described, it is understood that the present invention should not be limited to those embodiments, but that various changes and modifications may be made by one of ordinary skill in the art within the spirit and scope of the present invention as hereinafter claimed.

What is claimed is:

1. A backlight device comprising:
a backlight array adapted to provide a display panel with light, such that the display panel displays an image;
a plurality of backlight drivers adapted to drive the backlight array; and
a controller adapted to select one backlight driver of the plurality of backlight drivers in response to backlight driving information supplied from an external device and transmit the backlight driving information to the selected backlight driver.

2. The backlight device of claim 1, wherein the controller comprises:
a plurality of channels connected, respectively, to the plurality of the backlight drivers; and
a multiplexer adapted to enable one of the channels in response to the backlight driving information.

3. The backlight device of claim 2, wherein the backlight driving information comprises channel selection information to select one of the channels.

4. The backlight device of claim 3, wherein the channel selection information comprises a combination of a prescribed number of bits.

5. The backlight device of claim 1, wherein the backlight array comprises a plurality of groups connected to the backlight drivers, respectively,
wherein each group comprises sub-groups, and
wherein a number of the sub-groups is equal to or less than that of the sub-groups driven by a corresponding backlight driver.

6. The backlight device of claim 5, wherein each sub-group comprises a plurality of light emitting diodes connected to each other in series.

7. The backlight device of claim 5, wherein the sub-groups included in a same group are arranged adjacent to each other.

8. The backlight device of claim 5, wherein the sub-groups included in a same group are alternately arranged with a sub-group included in a different group.

9. The backlight device of claim 1, wherein the backlight driving information is transmitted through a system management bus scheme.

10. A method of driving a backlight device, the method comprising:
selecting one of a plurality of backlight drivers to drive a backlight array in response to backlight driving information supplied from an external device;
transmitting the backlight driving information to the selected backlight driver;
generating a driving signal based on the backlight driving information; and
generating light in response to the driving signal.

11. The method of claim 10, wherein the selecting of the backlight drivers comprises enabling one of a plurality of channels that are connected, respectively, to the plurality of backlight drivers.

12. The method of claim 11, wherein the backlight driving information comprises channel selection information to select one of the channels.

13. The method of claim 12, wherein the channel selection information comprises a combination of a prescribed number of bits.

14. The method of claim 10, wherein the backlight driving information is transmitted through a system management bus scheme.

15. A display apparatus comprising:
a display panel adapted to display an image; and
a backlight unit adapted to provide the display panel with light in response to backlight driving information supplied from an external device,
wherein the backlight unit comprises:
a backlight array adapted to provide the display panel with the light;
a plurality of backlight drivers adapted to drive the backlight array; and
a controller adapted to select one backlight driver of the backlight drivers in response to the backlight driving information and transmit the backlight driving information to the selected backlight driver.

16. The display apparatus of claim 15, wherein the controller comprises:
a plurality of channels connected, respectively, to the plurality of backlight drivers; and
a multiplexer adapted to enable one of the channels in response to the backlight driving information.

17. The display apparatus of claim 16, wherein the backlight driving information comprises channel selection information to select one of the channels.

18. The display apparatus of claim 17, wherein:
the backlight array comprises a plurality of groups that are connected, respectively, to the plurality of backlight drivers,
wherein each group comprises sub-groups, and
wherein a number of the sub-groups is equal to or less than that of the sub-groups driven by a corresponding backlight driver.

19. The display apparatus of claim 18, wherein each sub-group comprises a plurality of light emitting diodes connected to each other in series.

20. The display apparatus of claim 15, wherein the backlight driving information is transmitted through a system management bus scheme.
